(19) United States
(12) Patent Application Publication
(10) Pub. No.: US 2010/0122763 A1
(43) Pub. Date: May 20, 2010

(54) Composites and Methods of Making the Same

(75) Inventor: Marcel J. Schubiger, Galgenen (CH)

Correspondence Address: GFD PATENTS, LLC, P.O. BOX 752, CLIFTON PARK, NY, 12065, US

(73) Assignee: IQ TEC SWITZERLAND GMBH, Galgenen (CH)

(21) Appl. No.: 12/618,736

(22) Filed: Nov. 15, 2009

Related U.S. Application Data
(60) Provisional application No. 61/114,990, filed on Nov. 14, 2008.
(60) Provisional application No. 61/180,838, filed on May 23, 2009.

(51) Int. Cl. B29C 70/44; B29C 70/36

(52) U.S. Cl. 156/245; 156/500; 156/285

(57) ABSTRACT

An apparatus and method for forming a shape of a composite assembly, comprising: a mold having a first surface and a vacuum bag thereon, wherein the vacuum bag comprises a plurality of vacuum bag sheet(s), and a composite assembly therein, wherein the composite assembly comprises a plurality of bondable layers, wherein at least one of the plurality of sheet(s) of the vacuum bag is between the plurality of bondable layers and the first surface of the mold, and wherein the plurality of bondable layers are able to retain a shape which is the negative image of the mold when the pressure of the inside of the vacuum bag is reduced, even if the bag and plurality of bondable layers of the composite assembly are removed from the mold.

### FIELD OF THE INVENTION

The present invention relates generally to an apparatus and method for molding parts. Specifically, it is an apparatus and method for making multi-layer parts.

### BACKGROUND

There is a growing demand by industry, governmental regulatory agencies and consumers for durable and inexpensive products that are functional comparable or superior to metal products. This is particularly true in the automotive and transportation industry. Developers and manufacturers of these products are concerned with the strength parameters, such as impact, bending, stretching, and twisting resilience, while minimizing weight. To meet these demands, a number of reactive thermoplastic and thermoset composite pre-pregs, thermoset and thermoplastic based fully polymerized and consolidated sheets (together called composite sheets), and sandwich materials based on various composite sheets and core materials have been engineered. These materials are usually processed slowly in molds or presses primarily because it takes a long time to heat and cool the mold or press. This long time ends up increasing cost. Therefore there is a need for an improved apparatus and method for making multi-layer parts that is quick to heat yet holds its shape during processing.

### SUMMARY OF THE INVENTION

A first aspect of the present invention provides an apparatus for forming a shape of a composite assembly, comprising: a mold having a first surface and a vacuum bag thereon, wherein the vacuum bag comprises a plurality of vacuum bag sheet(s), and a composite assembly therein, wherein the composite assembly comprises a plurality of bondable layers, wherein at least one of the plurality of sheet(s) of the vacuum bag is between the plurality of bondable layers and the first surface of the mold, and wherein the plurality of bondable layers are able to retain a shape which is the negative image of the mold when the pressure of the inside of the vacuum bag is reduced, even if the bag and plurality of bondable layers of the composite assembly are removed from the mold.

A second aspect of the present invention provides a method for forming a shape of a composite assembly, comprising: providing a mold having a first surface and a vacuum bag thereon, wherein the vacuum bag comprises a plurality of vacuum bag sheet(s); providing an apparatus, such as a composite assembly, comprising a plurality of bondable layers, wherein the plurality of bondable layers of the composite assembly are contained within the plurality of sheets of the vacuum bag, wherein at least one of the plurality of sheet(s) of the vacuum bag are between the plurality of bondable layers of the composite assembly and the first surface of the mold; and reducing the pressure inside the plurality of sheet(s) of the vacuum bag so that the plurality of bondable layers are able to retain a shape which is the negative image of the first surface of the mold when the pressure of the inside of the vacuum bag is reduced even when the plurality of bondable layers of the composite assembly are removed from the mold.

A third aspect of the present invention provides An apparatus for forming a composite assembly having a composite material support structure (web), comprising: a mold having first and second surfaces; an outer vacuum bag, a plurality of inner vacuum bag(s) and a composite assembly having a composite material support structure (web) therebetween, wherein the composite material support structure (web) runs along an axis orthogonal to a longitudinal axis of the composite assembly, wherein the outer vacuum bag has a shape of a tube, wherein the outer vacuum bag comprises a first sheet conformed against the first surface of the mold and a second sheet conformed against a second surface of the mold, wherein the composite assembly comprises at least one bondable layer(s) Lₙ, wherein n=0, −1, −2 . . . −i, and wherein a first surface of the at least one bondable layer(s) Lₙ₌₀ of the composite assembly faces and conforms to either a shape of the first surface of the mold and a shape of the first sheet of the outer vacuum bag or to a shape of the second surface of the mold and to a shape of the second sheet of the outer vacuum bag, wherein each successive underlying at least one bondable layer(s) Lₙ, wherein n=−1, −2, . . . −i, conforms to the respective overlying layer Lᵢ₊ₙ, wherein n=−2, −3, . . . −i, wherein Lₙ, wherein n=−1, −2, . . . −i+1, represents successive underlying at least one bondable layer(s) (Lₙ) of the composite assembly, wherein n=−i, represents a bottom underlying at least one bondable layer(s) (Lₙ) of the composite assembly, wherein the first and second sheet(s) of the vacuum bag separate the at least one bondable layer(s) (Lₙ) of a composite assembly from the first and second surfaces of the mold, wherein the plurality of inner vacuum bag(s) comprise first and second radially expandable sheet(s), disposed about the web's axis, orthogonal to the longitudinal axis of the composite assembly, conformable to a shape of the at least one L₍₋ᵢ₎ layer(s) of the composite assembly, and wherein the at least one bondable layer(s) of the composite assembly being conformed to the shape of the respective shape first sheet of the outer vacuum bag and the first surface of the mold or the shape of the second sheet of the outer vacuum bag and the second surface of the mold are able to retain a shape which is the negative image of the respective first and second surfaces when the vacuum bag is evacuated even if the bag and plurality of bondable layers of the composite assembly are removed from the mold.

A fourth aspect of the present invention provides an apparatus for retaining a shape of a hollow composite assembly, comprising: a mold having an internal surface; an outer vacuum bag, at least one inner vacuum bag(s) and the hollow composite assembly, therebetween, wherein the hollow composite assembly comprises i bondable layer(s) L_{X} between the inner at least one vacuum bag(s) and the outer vacuum bag, wherein the i bondable layer(s) Lₓ comprise i₁ bondable layer(s) Lₓ of a first type and i₂ bondable layer(s) Lₓ of a second type, wherein circumferential portions Cₓ of the i bondable layer(s) Lₓ surround a common point within the hollow composite assembly, wherein x=1, 2, 3, . . . (i−1), i; wherein the i bondable layer(s) L_{X} of the first and second types are denoted as L₁, L₂, L₃ . . . , L₍ᵢ₋₁₎, Lᵢ, in order of decreasing distance between a respective point within the circumferential portions of the bondable layer(s) Lₓ of the first and second types and the common point, wherein i is any positive integer greater than or equal to 1, wherein i=i₁+i₂, wherein i₁≧0, and i₂≧0, wherein i₁+i₂≧1, wherein each i₂ bondable layer(s) Lₓ of the second type comprises at least one radial portion(s) Rₓ that are coextensive with each respective circumferential portion Cₓ of the bondable layer(s) Lₓ of the second type, wherein the circumferential portions Cₓ of the i₁ bondable layer(s) Lₓ of the first type and the circumferential Cₓ and radial Rₓ portions of the i₂ bondable layer(s) Lₓ of the second type have outer and inner surfaces, wherein a distance between points along each outer surface of the circumferential portions Cₓ of the i bondable layer(s) L_{X} and the common point is greater than a distance between a respective point along the inner surface of the circumferential portions Cₓ of the i bondable layer(s) L_{X} of the first and second types and the common point, wherein a first space separates a wall of the outer vacuum bag from the internal surface of the mold, and wherein a second space separates the hollow composite assembly from the wall of the outer vacuum bag and a wall of the at least one inner vacuum bag(s), wherein, when the wall of the outer vacuum bag and the i bondable layer(s) L₁, L₂, L₃ . . . , L₍ᵢ₋₁₎, Lᵢ of the hollow composite assembly are conformed to the internal surface of the mold, a shape of the wall of the outer vacuum bag and the i bondable layer(s) L₁, L₂, L₃ . . . , L₍ᵢ₋₁₎, Lᵢ of the first and second types of the hollow composite assembly is the negative image of the internal surface of the mold, when the first space between the internal surface of the mold and the wall of the outer vacuum bag and the second space separating the composite assembly from the wall of the outer vacuum bag and a wall of the at least one inner vacuum bag(s) are under vacuum, wherein the at least one radial portion(s) Rₓ that are coextensive with each respective circumferential portion Cₓ of the bondable layer(s) Lₓ of the second type establish or fix a distance between points within each circumferential portion Cₓ of the i bondable layer(s) L_{X} of the first and second types and the common point so that a distance between respective points and the common point is essentially the same when the hollow composite assembly and the outer and inner vacuum bags are within the mold as when they are removed from the mold.

A fifth aspect of the present invention provides an apparatus for retaining a shape of a hollow composite assembly, comprising: an outer vacuum bag, at least one inner vacuum bag(s) and the hollow composite assembly, therebetween, wherein the hollow composite assembly comprises i bondable layer(s) L_{X} between the inner at least one vacuum bag(s) and the outer vacuum bag, wherein the i bondable layer(s) L_{X} comprise i₁ bondable layer(s) L_{X} of a first type and i₂ bondable layer(s) L_{X} of a second type, wherein circumferential portions C_{X} of the i bondable layer(s) L_{X} surround a common point within the hollow composite assembly, wherein x=1, 2, 3, . . . (i−1), i; wherein the i bondable layer(s) L_{X} of the first and second types are denoted as L₁, L₂, L₃ . . . , L₍ᵢ₋₁₎, Lᵢ, in order of decreasing distance between a respective point within the circumferential portions of the bondable layer(s) L_{X} of the first and second types and the common point, wherein I is any positive integer greater than or equal to 1, wherein i=i₁+i₂, wherein i₁≧0, and i₂≧0, wherein i₁+i₂≧1, wherein each i bondable layer(s) L_{X} of the second type comprises at least one radial portion(s) Rₓ that are coextensive with each respective circumferential portion of the bondable layer(s) L_{X} of the second type, wherein the circumferential portions of the i₁ bondable layer(s) L_{X} of the first type and the circumferential and radial portions of the i₂ bondable layer(s) L_{X} of the second type have outer and inner surfaces, wherein a distance between points along each outer surface of the i bondable layer(s) L_{X} and the common point is greater than a distance between a respective point along the inner surface and the common point, wherein a first space separates a wall of the outer vacuum bag from the internal surface of the mold, and wherein a second space separates the composite assembly from the wall of the outer vacuum bag and a wall of the at least one inner vacuum bag(s), wherein, when the wall of the outer vacuum bag and the i bondable layer(s) L₁, L₂, L₃ . . . , L₍ᵢ₋₁₎, Lᵢ of the hollow composite assembly are conformed to an internal surface of a mold, a shape of the wall of the outer vacuum bag and the i bondable layer(s) L₁, L₂, L₃ . . . , L_{(I-1)}, L_{I} of the hollow composite assembly is the negative image of the internal surface of the mold, when the first space between the internal surface of the mold and the wall of the outer vacuum bag and the second space separating the composite assembly from the wall of the outer vacuum bag and a wall of the at least one inner vacuum bag(s) are under vacuum, wherein the at least one radial portion(s) R_{X} that are coextensive with each respective circumferential portion of the bondable layer(s) L_{X} of the second type establish or fix a distance between points within each circumferential portion of the i bondable layer(s) L_{X} and the common point so that a distance between respective points and the common point is essentially the same when the hollow composite assembly and the outer and inner vacuum bags are within the mold as when they are removed from the mold.

A sixth aspect of the present invention provides a method of making a hollow composite assembly, comprising: providing a mold having an inner surface; providing an outer vacuum bag, at least one inner vacuum bag(s) and the hollow composite assembly, therebetween, wherein the hollow composite assembly comprises i bondable layer(s) L_{X} between the inner at least one vacuum bag(s) and the outer vacuum bag, wherein the i bondable layer(s) L_{X} comprise i₁ bondable layer(s) L_{X} of a first type and i₂ bondable layer(s) L_{X} of a second type, wherein circumferential portions C_{X} of the i bondable layer(s) L_{X} surround a common point within the hollow composite assembly, wherein x=1, 2, 3, . . . (i−1), i; wherein the i bondable layer(s) L_{X} of the first and second types are denoted as L₁, L₂, L₃ . . . , L₍ᵢ₋₁₎, Lᵢ, in order of decreasing distance between a respective point within the circumferential portions of the bondable layer(s) L_{X} of the first and second types and the common point, wherein i is any positive integer greater than or equal to 1, wherein i=i₁+i₂, wherein i₁≧0, and i₂≧0, wherein i₁+i₂≧1, wherein each bondable layer(s) L_{X} of the second type comprises at least one radial portion(s) R_{X} that are coextensive with each respective circumferential portion of the bondable layer(s) L_{X} of the second type, wherein the circumferential portions of the i₁ bondable layer(s) L_{X} of the first type and the circumferential and radial portions of the i₂ bondable layer(s) L_{X} of the second type have outer and inner surfaces, wherein a distance between points along each outer surface of the i bondable layer(s) L_{X} and the common point is greater than a distance between a respective point along the inner surface and the common point, wherein a first space separates a wall of the outer vacuum bag from the internal surface of the mold, and wherein a second space separates the composite assembly from the wall of the outer vacuum bag and a wall of the at least one inner vacuum bag(s), providing a vacuum to a first and second spaces, wherein, the wall of the outer vacuum bag and the i bondable layer(s) L₁, L₂, L₃ . . . , L_{(I-1)}, L_{I} of the hollow composite assembly are conformed to an internal surface of the mold, a shape of the wall of the outer vacuum bag and the i bondable layer(s) L₁, L₂, L₃ . . . , L_{(I-1)}, L_{I} of the hollow composite assembly is the negative image of the internal surface of the mold, when the first space between the internal surface of the mold and the wall of the outer vacuum bag and the second space separating the composite assembly from the wall of the outer vacuum bag and a wall of the at least one inner vacuum bag(s) are under vacuum, removing the hollow composite assembly from the mold, wherein, the wall of the outer vacuum bag and the i bondable layer(s) L₁, L₂, L₃ . . . , L_{(I-1)}, L_{I} of the hollow composite assembly retain the shape of the wall of the outer vacuum bag and the i bondable layer(s) L₁, L₂, L₃ . . . , L_{(I-1)}, L_{I} of the hollow composite assembly that is the negative image of the internal surface of the mold, and wherein the at least one radial portion(s) R_{X} that are coextensive with each respective circumferential portion of the bondable layer(s) L_{X} of the second type establish or fix a distance between points within each circumferential portion of the i bondable layer(s) L_{X} and the common point so that a distance between respective points and the common point is essentially the same when the hollow composite assembly and the outer and inner vacuum bags are within the mold as when they are removed from the mold.

In one embodiment, the method of making a hollow composite assembly, further comprises removing the composite assembly and the vacuum bag from the mold and heating the composite assembly inside the vacuum bag between about 80° C. and 260° C.

A seventh aspect of the present invention provides A method for fixing the solid geometric shape of a hollow composite assembly, comprising: withdrawing air from a first space, in antiparallel directions, resulting in conforming a wall of an inner vacuum bag to a surface of a mold; withdrawing air from a second space, in antiparallel directions, resulting in conforming a wall of an outer vacuum bag to a wall of the hollow composite assembly; said conforming the wall of the outer vacuum bag to the wall of the hollow composite fixing the geometric shape of the hollow composite assembly, resulting in the hollow composite assembly having a shape in the negative image of the surface of the mold

### BRIEF DESCRIPTION OF THE DRAWINGS

The features of the invention are set forth in the appended claims. The invention itself, however, will be best understood by reference to the following detailed description of an illustrative embodiment when read in conjunction with the accompanying drawings, wherein:

FIG. 1 depicts a cross-sectional view of an assembly, having a plurality of layers, before bending;

FIG. 2 depicts a cross-sectional view of the assembly depicted in FIG. 1, after bending, without clamping or bonding adjacent layers;

FIG. 3 depicts a cross-sectional view of the assembly depicted in FIG. 1, wherein adjacent layers are first bonded (or clamped), then bent in order to contrast bending with and without clamping;

FIG. 4 depicts a cross-sectional view of an apparatus for making a multi-layer apparatus, according to embodiments of the present invention;

FIG. 5 depicts the cross-sectional view of the apparatus depicted in FIG. 4, after evacuating a vacuum bag, according to embodiments of the present invention;

FIG. 6 depicts the cross-sectional view of the apparatus depicted in FIG. 5, after removing a mold, according to embodiments of the present invention;

FIGS. 7A-B depict a flow diagram of a method for free-forming a shape of a composite assembly, according to embodiments of the present invention;

FIGS. 8A-8B depicts a longitudinal cross-sectional view of an apparatus for retaining a shape of a hollow composite assembly, according to embodiments of the present invention;

FIG. 8C depicts a flow diagram for a method for retaining a shape of a composite assembly, according to embodiments of the present invention;

FIG. 9 depicts an end cross-sectional view of the apparatus for retaining the shape of the hollow composite assembly, according to embodiments of the present invention;

FIG. 10 depicts an exploded view of the end-cross-sectional view of the apparatus for retaining the shape of the hollow composite assembly, depicted in FIG. 9, according to embodiments of the present invention;

FIG. 11 depicts the end cross-sectional view of the apparatus for retaining the shape of the hollow composite assembly, depicted in FIG. 8, according to embodiments of the present invention; and

FIGS. 12A-12B depict a flow diagram describing a method for making a hollow composite assembly, according to embodiments of the present invention.

### DETAILED DESCRIPTION OF EMBODIMENTS OF THE INVENTION

The invention meets a need in the art by providing multi-layered parts, and methods of forming therewith.

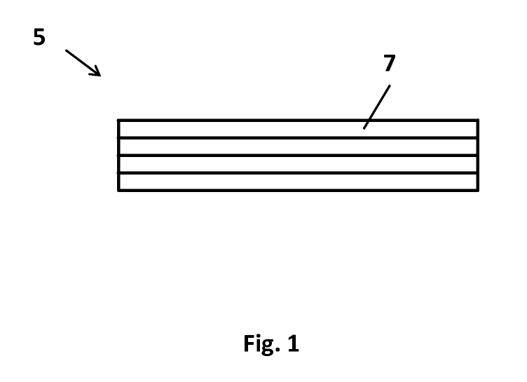

FIGS. 1-3 illustrate the effect of clamping or bonding multi-layered composite assemblies. Bending stiffness of a sheet of a particular homogeneous material (aluminum, steel for example) will increase with the cube of its thickness. So, if the thickness doubles, the bending stiffness goes up by 8, if the thickness triples the bending stiffness goes up by 27, and so on. It is also well known that multiple layers of sheets will have much lower bending stiffness if they are not bonded or clamped so they act as one, compared to the bonded or clamped case. This difference has to do with the difference between the cube of the sum of the thicknesses (Σi)³, which is the bonded case, and the sum of the cubes of the individual thicknesses Σ(i³), which is the unbonded case.

FIG. 1 depicts a cross-sectional view of an assembly 5, having a plurality of layers 7, in which adjacent layers are free to slide relative to one another. A nominal thickness of 1 (for example) may be assigned to each layer 7 of assembly 5 in FIG. 1.

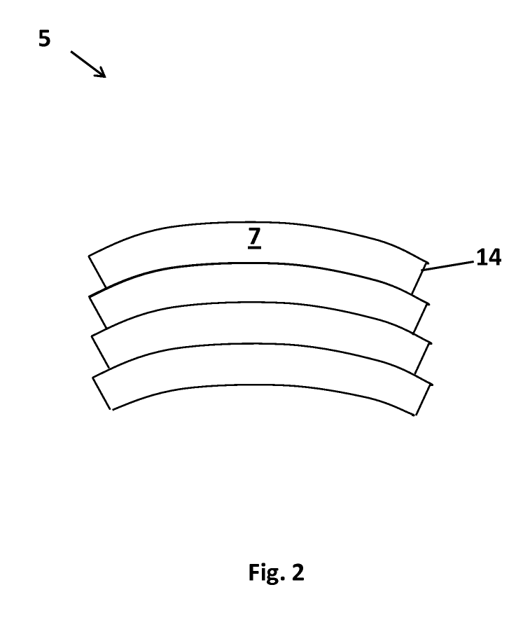

FIG. 2 depicts the cross-sectional view of the assembly 5, having a plurality of layers 7, depicted in FIG. 1, after bending, without clamping adjacent layers 7. Each of four (4) layers 7 shown in FIG. 2 may slide relative to each adjacent layer, as can be seen by the overlapping of respective ends 14 of each successive adjacent layer 7. Therefore, the assembly 5 may be assigned a contribution from thickness to bending stiffness of 4, since each layer 7 bends individually, with a thickness contribution to bending stiffness of 1³ for each of the four (4) layers 7, 4 total.

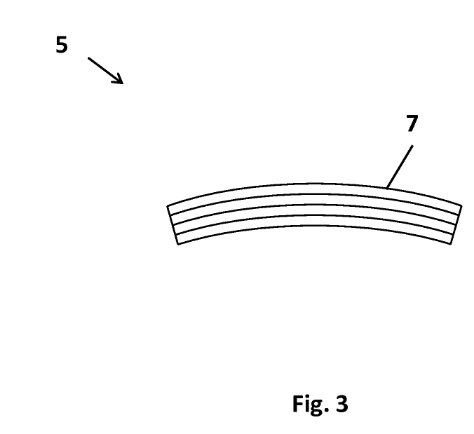

FIG. 3 depicts the cross-sectional view of the assembly 5, having a plurality of layers 7, depicted in FIG. 1, after bending, with clamping of adjacent layers 7 applied before bending. The adjacent layers 7 may be bent, although they are clamped together. In FIG. 3, the four (4) adjacent layers 7 interact and tend to bend as an integral unit. Therefore, the assembly 5 may be assigned a contribution from thickness to bending stiffness of 4³=64, which is 16 times greater than the bending stiffness of the unclamped assembly 5 based on 4³ for the four (4) layers 7, 64 total. This shows the effect of clamping or bonding the layers together on bending stiffness of the assembly 5.

The clamping effect may be achieved by a creating a vacuum around the assembly 5, such as by placing the assembly 5 in a vacuum bag. An objective of the invention is to bend the composite assembly before the vacuum is applied, so the layers slide and the assembly bends easily, then once the desired shape is achieved, another objective of the invention is to use vacuum to apply and provide the clamping of adjacent layers 7 and the stiffening effect, so the assembly can be removed from a mold. The vacuum bag stiffening effect is then maintained through the process of bonding of the layers by some means. The part can then be removed from the vacuum bag and retain its shape. The clamping effect may also be achieved by placing a vacuum bag around a sandwich panel with a core and a skin on each side by applying vacuum to the sandwich panel.

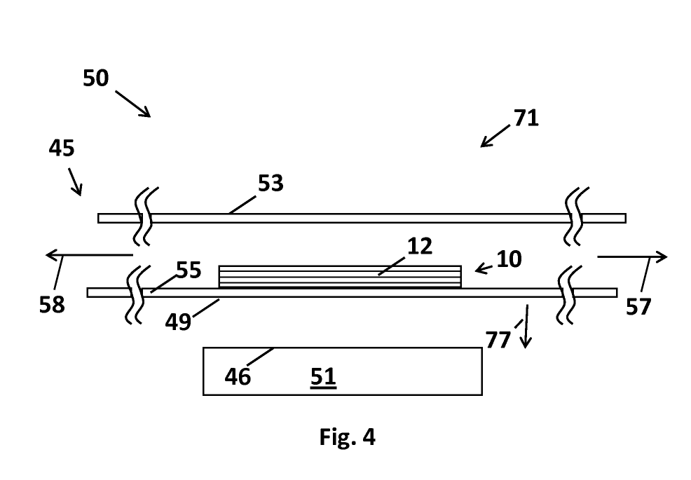

FIG. 4 depicts a cross-sectional view of an apparatus 50 for making apparatus 10, such as a multi-layered composite part 10, having a plurality of bondable layer(s) 12. The apparatus 50 comprises: an apparatus 71, and a mold 51, having a first surface 46. The apparatus 71 comprises a vacuum bag 45, and an apparatus 10, such as reactive thermoplastic or thermoset composite pre-pregs, thermoset and thermoplastic based fully polymerized and consolidated sheets (together called composite sheets), and sandwich materials based on various composite sheets and core materials, in the vacuum bag 45. The vacuum bag 45 comprises a plurality of vacuum bag sheets 53, 55.

In one embodiment, the apparatus 50 for forming a shape of the apparatus 10, such as a composite assembly, comprises: a mold 51 having a first surface 46 and a vacuum bag 45 thereon, wherein the vacuum bag 45 comprises a plurality of vacuum bag sheet(s) 53, 55, and the apparatus 10 therein.

The apparatus 10 comprises a plurality of bondable layers 12. Hereinafter, “bondable layer(s)” is defined as layers that are to be chemically or physically coupled by a bonding agent, such as by an adhesive. Typical adhesives may be a thermoplastic or thermoset resin. One of the plurality of sheet(s) 55 of the vacuum bag 45 are between the plurality of bondable layers 12 and the first surface of the mold 46. Vacuum may be applied between the first surface 46 of the mold 51 and the bottom surface 49 of the apparatus 71, thereby conforming a shape of the bottom surface 49 of the apparatus 71 to the reverse image of the first surface 46 of the mold 51. The bottom surface 49 of the apparatus 71 may be prepared for applying vacuum by taping it to the first surface 46 of the mold 51, thereby sealing the bottom surface 49 of the apparatus 71 to the first surface 46 of the mold 51.

Applying vacuum in the direction of arrow 77 between the bottom surface 49 of the apparatus 71 and the first mold surface 46 draws the apparatus 71 toward the first mold surface 46 in the direction of the arrow 77 and conforms the shape of the surface 49 of apparatus 71 to the mold surface 46. Alternatively, the force in the direction of arrow 77 could be physical pressure, or other means, to hold the surface 49 of the apparatus 71 against the first surface 46 of the mold 51.

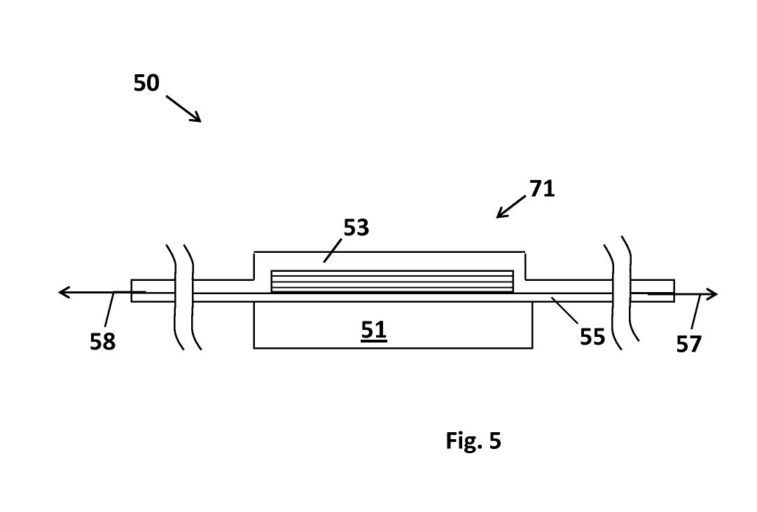

FIG. 5 depicts the cross-sectional view of the apparatus 50 depicted in FIG. 4, after evacuating a vacuum bag 45 by removing air from the vacuum bag 45. Vacuum is applied in the direction of the arrows 57, 58 between the top and bottom vacuum bag sheets 53, 55, clamping the apparatus 10, such as a composite assembly inside, and forming it to the reverse image of the first surface 46 of the mold 51.

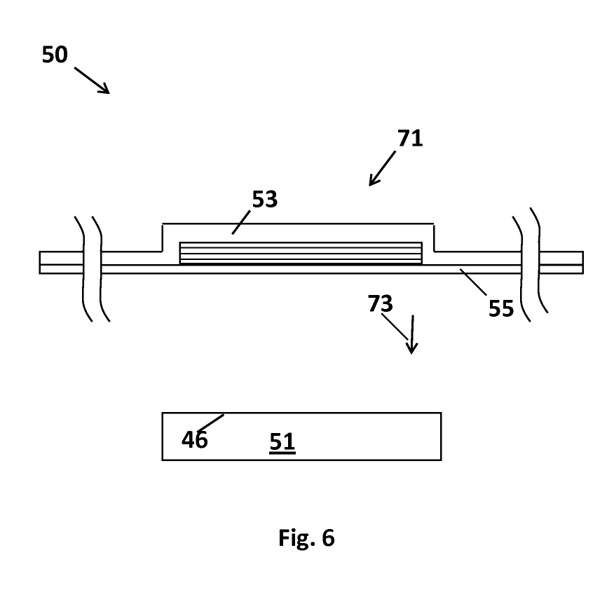

FIG. 6 depicts the cross-sectional view of the apparatus 71 depicted in FIG. 5, after removing the mold 51 in the direction of the arrow 73. Vacuum is released between the bottom vacuum bag sheet 55 and the first surface 46 of the mold 51, thus freeing the apparatus 71 comprising the vacuum bag 45 and apparatus 10, such as a composite assembly, from the mold 51. The vacuum bag 45 and apparatus 10 is apparatus 71, such as a free standing assembly depicted in FIG. 6, and described in associated text, herein, which can now undergo further processing, such as a heating cycle, or simply time for a room temperature cure adhesive to bond the layers and allow removal of the part from the vacuum bag 45, while the first surface 46 of the mold 51 is available to form another apparatus 10.

The plurality of bondable layers 12 are able to retain a shape which is the negative image of the mold 51 when the pressure of the inside of the vacuum bag 45 is reduced, even if the bag 45 and plurality of bondable layers 12 of the apparatus 10, such as a composite assembly are removed from the mold 51.

The materials of the apparatus 10 may be formed into the desired shape while the vacuum is off, according to the shape of the first surface 46 of the mold 51, through the vacuum bag 45. The vacuum is then applied, locking the plurality of adjacent layers 12 of the apparatus 71. The apparatus 71 can then be heat processed in the mold 51 or in a second similarly shaped mold (not shown) that may be made of a different material than the first mold, or in an oven (not shown) by removing the apparatus 71 from the mold 51, or otherwise heat processed in a heating device between about 80° C. and about 260° C., without being attached to a shaping fixture, e.g., the mold 51. The mold 51 could be as simple as a flat plate, facilitating the manufacture of flat panels, or it could be as complex as a wind turbine blade.

In one embodiment, the mold 51 may be a cold forming mold, so the apparatus 10 may be released from the cold forming mold, and transferred to a hot mold for heat processing. Applying vacuum in the direction of arrow 77 between the bottom surface 49 of the apparatus 71 and the first mold surface 46 draws the apparatus 71 toward the first mold surface 46 in the direction of the arrow 77 and conforms the shape of the surface 49 of apparatus 71 to the mold surface 46. Providing intimate contact between the first mold surface 46 and the surface 49 of the apparatus 71 enables rapid heating and heat processing of the apparatus 10. The apparatus 10 may be demolded after heat processing, or it may be transferred to another cold mold for cooling.

In one embodiment, the plurality of bondable layers of the apparatus 10, such as a composite assembly, are reactive polymer pre-impregnated reinforcement materials (pre-pregs).

In one embodiment, the plurality of bondable layers of the apparatus 10, such as a composite assembly, are layers of preformed sheets of various materials and thicknesses according to the intended use.

In one embodiment, the plurality of bondable layers of the apparatus 10, such as a composite assembly, are preformed sheets on each side of a foam core, or other suitable core material.

In one embodiment, the plurality of bondable layers of the apparatus 10, such as a composite assembly, are combinations of reactive polymer pre-impregnated reinforcement materials (pre-pregs), layers of preformed sheets of various materials and thicknesses according to the intended use, or preformed sheets on each side of a foam core, or other suitable core material.

In one embodiment, the plurality of bondable layers of the apparatus 10, such as a composite assembly, are coupled by a bonding material. The bonding material may be a thermoset or a thermoplastic film adhesive, such as ethyl vinyl acetate (EVA).

Alternatively, the thermoplastic film is advantageously selected from the group consisting of the reactive (polymerizable) thermoplastic resin may be reactive macrocyclic oligomeric polyester, reactive macrocyclic oligomeric polybutyleneterephthalate, reactive macrocyclic oligomeric polyethyleneterephthalate, reactive macrocyclic oligomeric polycarbonate, and reactive lactam monomers.

The thermoset film is advantageously selected from the group consisting of epoxy resins, unsaturated polyester resins, vinyl ester resins, thermoset polyurethane resins, phenol-formaldehyde resins (phenolic resins), polyimide resins, silicone resins, crosslinked thermoplastic resins, e.g., cross linked polyethylene resins, cross linked polypropylene resins, and cross linked polyvinyl chloride resins. A comprehensive listing of thermoset resins may be found in “Handbook of Thermoset Resins,” 2^{nd} Edition, by Sidney H. Goodman, Noyes Publications, Westwood, N.J., ISBN: 0-8155-1421-2 (1998), which is hereby incorporated by reference.

In one embodiment, the apparatus 10, such as a composite assembly, comprises “non-bonding” layers to separate smooth finished surfaces of the composite assembly. The “non-bonded” layers may be thin sheets of material, wherein the material is selected from the group consisting of metal, and plastic, with a mold release agent between the non-bonding layer and the composite. The mold release agent may be a silicone release agent. The “non-bonding” layers may be thin sheets of material, wherein the material is selected from the group consisting of metal and plastic. The metal may advantageously be selected from the group consisting of steel, aluminum, copper, silver, and tin. The plastic may advantageously be plastic selected from the group consisting of polyethyleneterephthalate (PET), silicone, fluorinated ethylene propylene, polytetrafluoroethylene (PTFE), perfluoroalkoxy polymer resin, PFA, polyfluoroalkanes, polyethylene film, and polypropylene film.

In one embodiment, a shape of the first surface 46 of the mold 51 is selected from the group consisting of flat, concave, convex, and combinations thereof.

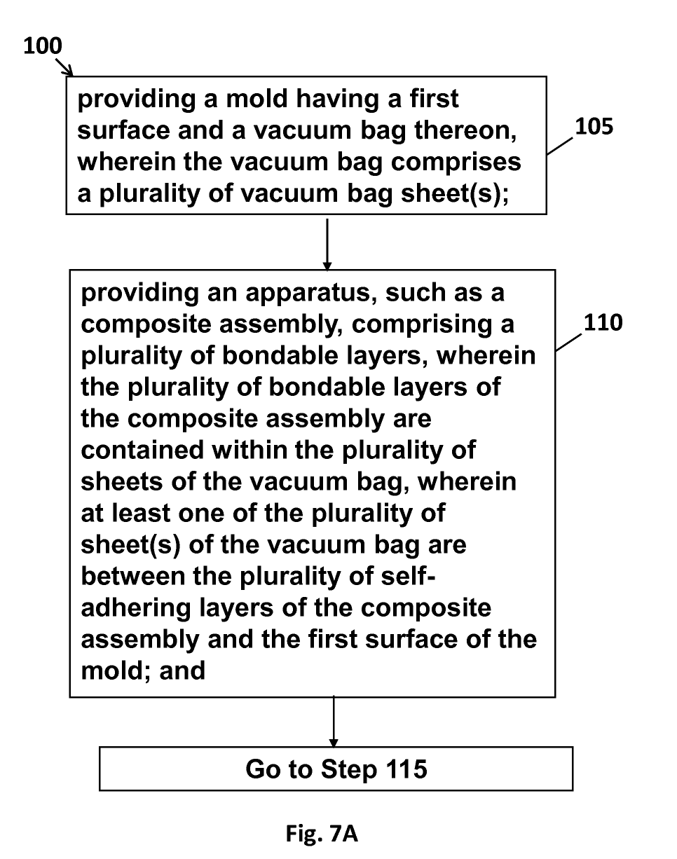

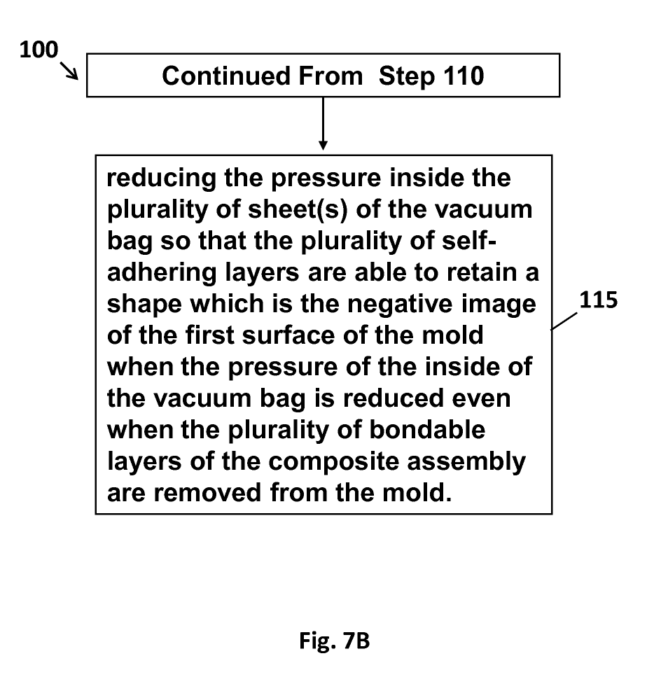

FIGS. 7A-7B depict a flow diagram of a method 100 for forming a shape of the apparatus 10, such as a composite assembly. The method 100 comprises a step 105, providing a mold 51 having a first surface 46 and a vacuum bag 45 thereon, wherein the vacuum bag 45 comprises a plurality of vacuum bag sheet(s) 53, 55.

In a step 110 of the method 200, an apparatus 10, such as a composite assembly, is provided, comprising a plurality of bondable layers 12, wherein the plurality of bondable layers 12 of the apparatus 10, such as the composite assembly, are contained within the plurality of sheets 53, 55 of the vacuum bag 45. At least one of the plurality of sheet(s) 53, 55 of the vacuum bag 45 are between the plurality of bondable layers 12 of the apparatus 10, such as the composite assembly, and the first surface 46 of the mold 51.

In a step 115 of the method 200, the pressure inside the plurality of sheet(s) 53, 55 of the vacuum bag 45 is reduced so that the plurality of bondable layers 12 are able to retain a shape which is the negative image of the first surface 46 of the mold 51 when the pressure of the inside of the vacuum bag 45 is reduced even when the plurality of bondable layers 12 of the apparatus 10, such as a composite assembly, are removed from the mold 51.

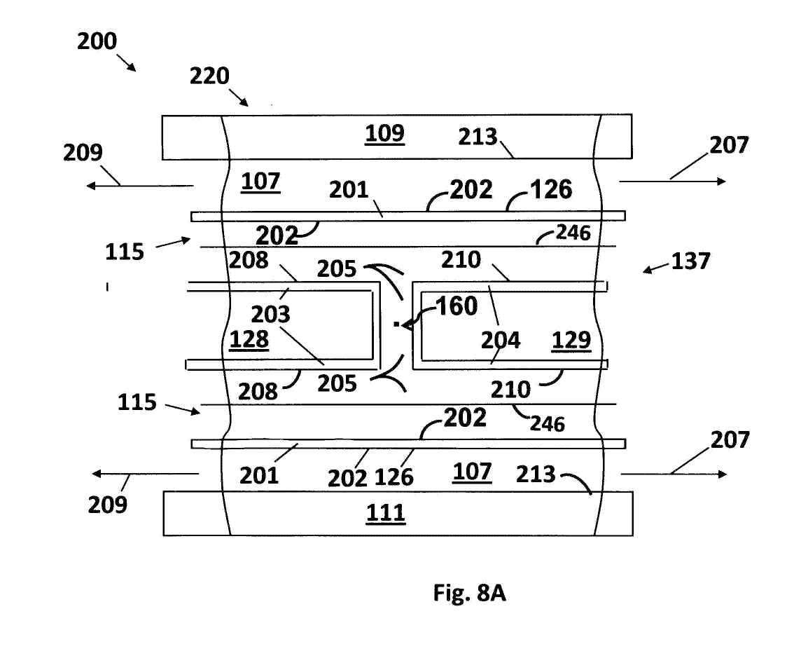

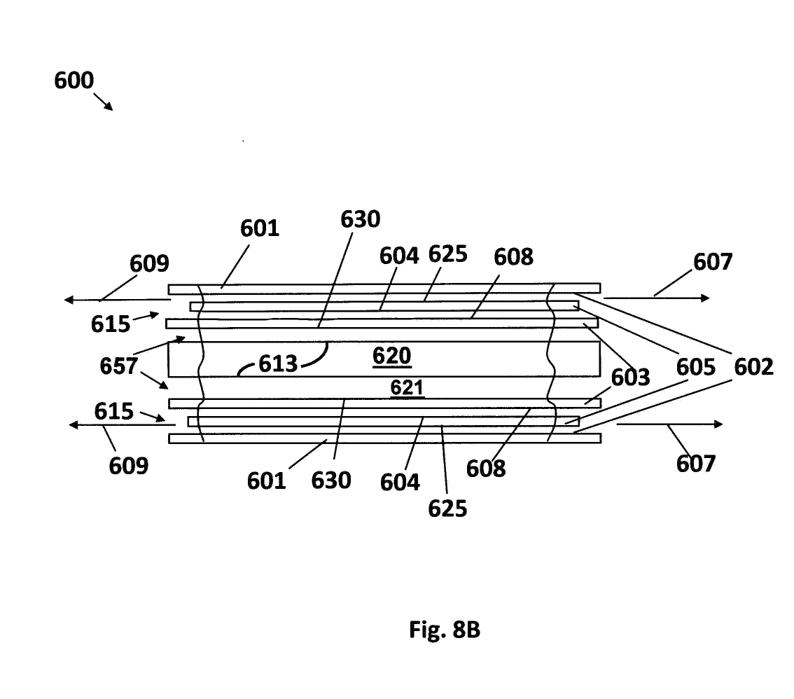

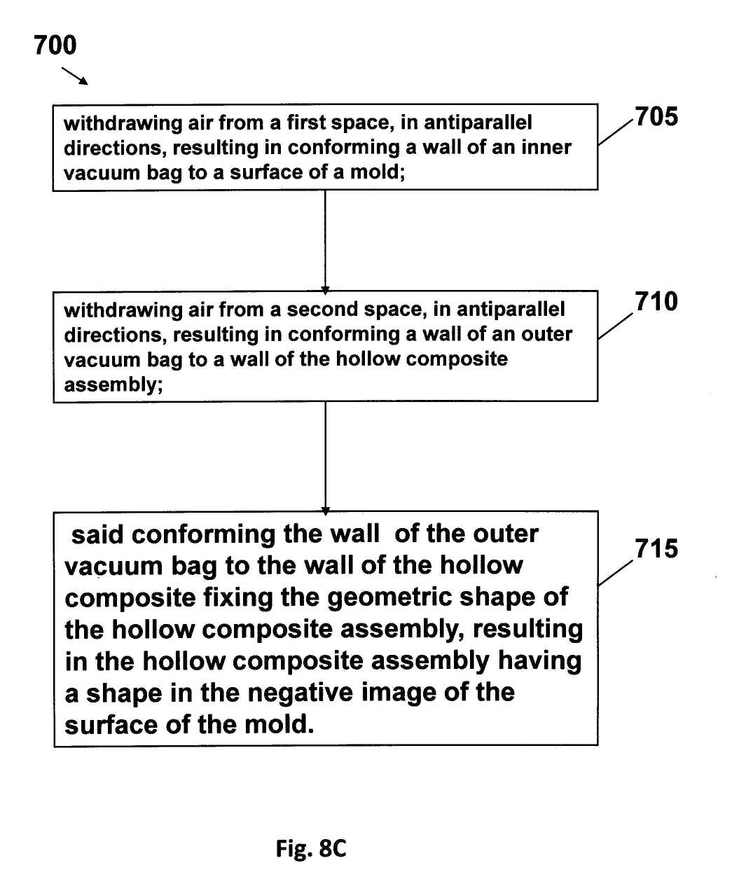

FIG. 8A depicts a longitudinal cross-sectional view of an apparatus 200 for retaining a shape of a hollow composite assembly 205, comprising: a mold 220, having an internal surface 213, an outer vacuum bag 201, “j” inner vacuum bag(s) 203, 204, wherein j is at least one, and the hollow composite assembly 205, therebetween. The mold 220 may comprise two halves 109, 111. A first space 107 may separate a wall 202 of the outer vacuum bag 201 from the internal surface 213 of the mold 220. A second space 115 separates the hollow composite assembly 205 from the wall 202 of the outer vacuum bag 201 and a wall 208, 210 of the j at least one inner vacuum bag(s) 203, 204.

FIG. 8B depicts a longitudinal cross-sectional view of an apparatus 600 for retaining a shape of a hollow composite assembly 605, comprising: a mold 620, having an outer surface 613, an outer vacuum bag 601, an inner vacuum bag 603, and the hollow composite assembly 605, therebetween. The mold 620 may be any solid shape, e.g., cylindrical, rhomboid, pyramidal, or the like. A first space 657 may separate a wall 630 of the inner vacuum bag 603 from the outer surface 613 of the mold 620. A second space 615 separates wall 604 of the hollow composite assembly 605 from the wall 608 of the inner vacuum bag and the wall 625 of the hollow composite assembly 605 from the wall 602 of the outer vacuum bag 601.

FIG. 8B depicts a longitudinal cross-sectional view of the apparatus 600 for retaining a shape of a hollow composite assembly 605, wherein the mold 620 is an internal mold.

FIG. 8C depicts a method 700 for advantageously fixing the solid geometric shape of the hollow composite assembly 605, depicted in FIG. 8B.

In a step 705 of the method 700, air may be withdrawn from the first space 657, in the antiparallel directions represented by the arrows 607, 609, resulting in conforming the wall 630 of the inner vacuum bag 603 to the surface 613 of the mold 620.

In a step 710 of the method 700, air may be withdrawn from the second space 615, in the antiparallel directions represented by the arrows 607, 609, resulting in conforming the wall 602 of the outer vacuum bag 601 to the wall 625 of the hollow composite assembly 605. Said conforming the wall 625 of the outer vacuum bag 601 to the wall 625 of the hollow composite assembly 605 fixes the geometric shape of the hollow composite assembly 605, resulting in the hollow composite assembly 605 having a shape in the negative image of the surface 613 of the mold 620.

In a step 715 of the method 700, the pressure in first space 657 may be allowed to return to atmospheric pressure, resulting in releasing the mold 620 so it can be removed, thereby forming the cavity 621 within the hollow composite assembly 605.

In one embodiment of the step 710 of the method 700, the air may be withdrawn from the spaces 657, 615 by withdrawing air via pumping, e.g., using a mechanical vacuum pump, or any appropriate means of evacuating the spaces 657, 615, in the direction of arrows 607 and 609.

In one embodiment of the step 710 of the method 700, the pressure in first space 657 may be allowed to return to atmospheric pressure, resulting in releasing the mold 620 so it can be removed, thereby forming a cavity 621 within the hollow composite assembly 605.

In one embodiment of the step 710 of the method 700, air is withdrawn from the first and second spaces 657, 615 by withdrawing the air via pumping.

In one embodiment of the step 710 of the method 700, the air is withdrawn by a mechanical vacuum pump, in the antiparallel directions represented by the arrows 607, 609, e.g., using the mechanical vacuum pump.

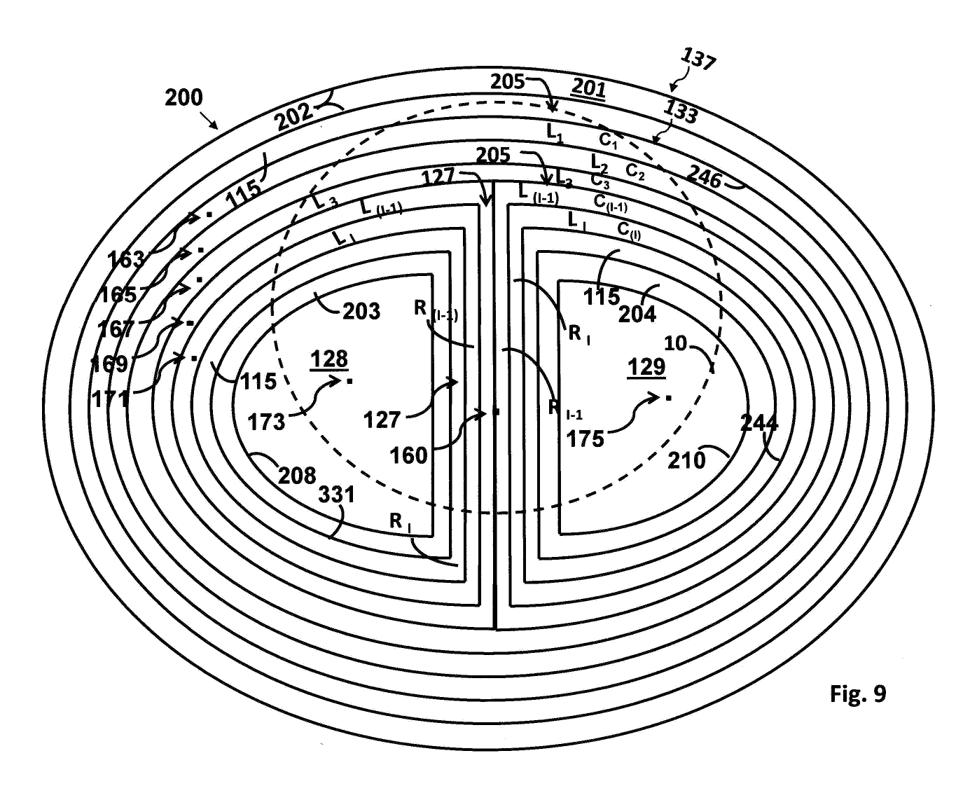

FIG. 9 depicts an end cross-sectional view of the apparatus 200 for retaining the shape of the hollow composite assembly 205. The hollow composite assembly 205 comprises i bondable layer(s) L_{X} between the inner at least one vacuum bag(s) 203, 204 and the outer vacuum bag 201, wherein X=1, 2, 3, . . . (i−1), i. The i bondable layer(s) L_{X} comprise i₁ bondable layer(s) L_{X} of a first type and i₂ bondable layer(s) L_{X} of a second type. The i₁ bondable layers(s) L_{X} of the first type have only C_{X} circumferential portion(s) 133. The i₂ bondable layers of the second type have C_{X} circumferential portion(s) 133 and Rₓ radial portion(s) 127. C_{X} circumferential portion(s) 133 of the i bondable layer(s) L_{X} surround a common reference point 160 within the hollow composite assembly 205, wherein X=1, 2, 3, . . . (i−1), i. i may be any positive integer greater than or equal to 1.

The number I of bondable layer(s) may be represented by formula: 1, as follows:

i=i₁+i₂, wherein i₁≧0, and i₂≧0, and wherein i₁+i₂≧1. (1)

The i bondable layer(s) L_{X} of the first and second types are denoted as L₁, L₂, L₃ . . . , L_{(I-1)}, L_{I}, in order of decreasing distance between a respective reference point 163, 166, 167, 169, and 171 within the C_{X} circumferential portion(s) 133 of the bondable layer(s) L_{X} of the first and second types and the common reference point 160. Each of the reference points 163, 166, 167, 169, and 171 lie along a plane that includes the common reference point 160, and are separated from the common reference point 160 by a distance “d”.

Each of the i₂ bondable layer(s) L_{X} of the second type comprises at least one R_{X} radial portion(s) 127 that are coextensive with each respective C_{X} circumferential portion(s) 133 of the i₂ bondable layer(s) L_{X} of the second type.

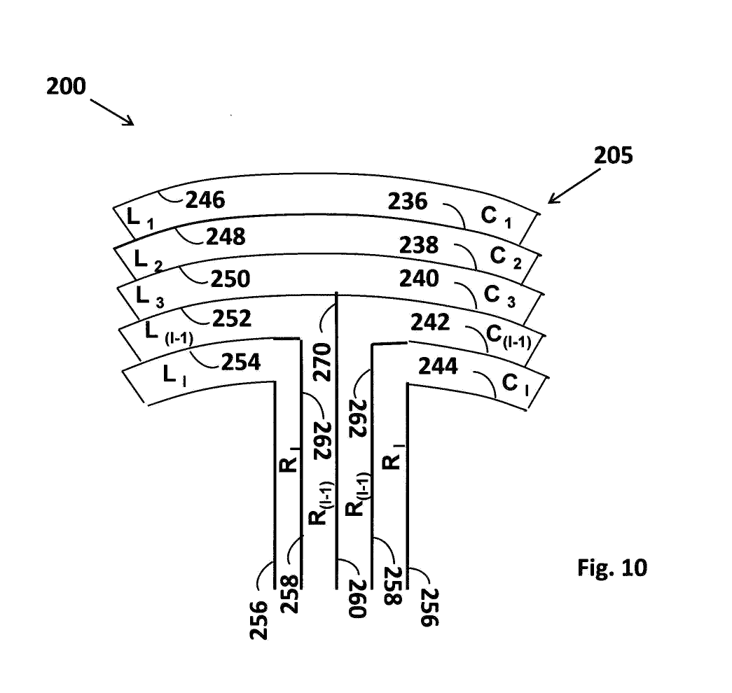

FIG. 10 depicts an exploded view of the end-cross-sectional view of the apparatus 200 for retaining the shape of the hollow composite assembly 205, depicted in FIG. 9, and described in associated text, herein. C_{X} circumferential portions 133 of the i₁ bondable layer(s) L_{X} of the first type, wherein X=1, 2, and 3, have inner surface(s) 236, 238, and 240, and outer surface(s) 246, 248, and 250. C_{X} circumferential portion(s) 133 of the i bondable layer(s) L_{X} of the second type, wherein X=(i−1) and i, have inner surface(s) 242 and 244, and outer surfaces 252 and 254.

Rₓ radial portion(s) 127 of the i₂ bondable layer(s) L_{X} of the second type, wherein X=(i−1) and I, have inner surface(s) 262, and 260, and 270, and outer surfaces 256, 258.

In FIG. 9, each j inner vacuum bag(s) 203, 204 forms a cavity 128, 129, and each cavity has a reference point 173, 175, wherein the reference points lie along a plane that includes the common reference point 160, and are separated from the common reference point 160 by a distance “d”.

A distance between reference points 163, 166, 167, 169, and 171 along each outer surface of the Cₓ circumferential portion(s) 133 of the i bondable layer(s) L_{X} of the first and second type and the common reference point 160 is greater than a distance between a respective point along the inner surface(s) 236, 238, 240, 242, and 244 of the Cₓ circumferential portion(s) 133 of the i bondable layer(s) L_{X} and the common reference point 160.

Referring to FIG. 8, a first space 107 separates a wall 202 of the outer vacuum bag 201 from the internal surface 213 of the mold 220. A second space 115 separates the hollow composite assembly 205 from the wall 202 of the outer vacuum bag 201 and a wall(s) 208, 210 of the j at least one inner vacuum bag(s) 203, 204.

When a 137, which includes the wall 202 of the outer vacuum bag 201, the i bondable layer(s) L₁, L₂, L₃ . . . , L_{(I-1)}, L_{I} of the first and second types of the hollow composite assembly 205, and the wall(s) 208, 210 of the j at least one inner vacuum bag(s) 203, 204 are conformed to the internal surface 213 of the mold 220, a shape of the wall 202 of the outer vacuum bag 201 and the i bondable layer(s) L₁, L₂, L₃ . . . , L_{(I-1)}, L_{I} of the first and second types of the hollow composite assembly 205 is the negative image of the internal surface 213 of the mold 220, when the first space 107 between the internal surface 213 of the mold 220 and the wall 202 of the outer vacuum bag 201 and the second space 115 separating the composite assembly 205 from the wall 202 of the outer vacuum bag 201 and the wall(s) 208, 210 of the j at least one inner vacuum bag(s) 203, 204 have a lower internal pressure than the internal pressure of the j at least one inner vacuum bags 203, 204.

In one embodiment, FIG. 8 depicts the first space 107 between the internal surface 213 of the mold 220 and the wall 202 of the outer vacuum bag 201 and the second space 115 separating the composite assembly 205 from the wall 202 of the outer vacuum bag may be placed at a lower internal pressure than the internal pressure of the j at least one inner vacuum bag(s) 203, 204 by withdrawing air via pumping, e.g., using a mechanical vacuum pump, or any appropriate means of evacuating the spaces 107 and 115, in the direction of arrows 207 and 209, while leaving the j at least one inner vacuum bag(s) 203, 204 open to a higher source of air pressure, such as atmospheric pressure.

The at least one R_{X} radial portion(s) 127 of the i₂ bondable layer(s) L_{X} of the second type that are coextensive with each respective Cₓ circumferential portion)s) 133 of the bondable layer(s) L_{X} of the second type establish or fix a distance between reference points 163, 166, 167, 169, and 171 within each Cₓ circumferential portion(s) 133 of the i bondable layer(s) L_{X} of the first and second types and the common reference point 160 so that a distance between respective reference points 163, 166, 167, 169, and 171 and the common reference point 160 is essentially the same when the hollow composite assembly 205 and the outer 201 and inner vacuum bags 203 are within the mold 220 as when they are removed from the mold 220.

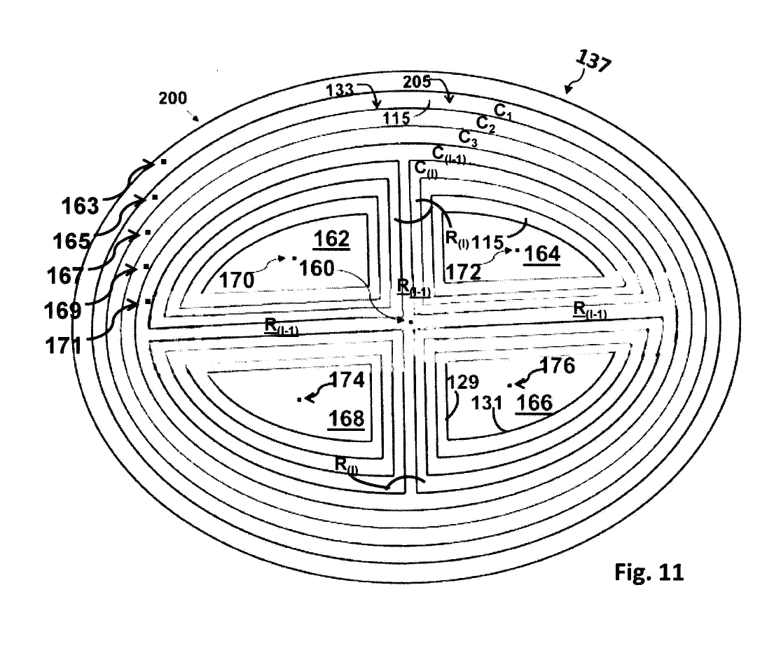

FIG. 11 depicts the end cross-sectional view of the apparatus 200 for

retaining the shape of the hollow composite assembly 205, depicted in FIG. 8, and described in associated text, comprising j inner vacuum bag(s) 203, 204, wherein j is equal to 4. Each j inner vacuum bag(s) 203, 204 forms a cavity 162, 164, 166, and 168, and each cavity has a reference point 170, 172, 174, and 176, wherein the reference points lie along a plane that includes the common reference point 160, and are separated from the common reference point 160 by a distance “d”.

In one embodiment, the j at least one inner vacuum bag(s) 203, 204 are advantageously expandable when the outer vacuum bag 201 is evacuated.

In one embodiment, the bondable layer(s) (L_{X}) of the hollow composite assembly 205 are reactive polymer pre-impregnated reinforcement materials (pre-pregs).

In one embodiment, the bondable layer(s) (L_{X}) of the hollow composite assembly 205 are layers of preformed sheets of various materials and thicknesses according to the intended use.

In one embodiment, the bondable layer(s) (L_{X}) of the hollow composite assembly 205 are preformed sheets on each side of a foam core, or other suitable core material.

In one embodiment, the bondable layer(s) (L_{X}) of the hollow composite assembly 205 are combinations of reactive polymer pre-impregnated reinforcement materials (pre-pregs), layers of preformed sheets of various materials and thicknesses according to the intended use, or preformed sheets on each side of a foam core, or other suitable core material.

In one embodiment, the bondable layer(s) (L_{X}) are coupled by a bonding material.

In one embodiment, the bonding material coupling the bondable layers Lₓ is a thermoplastic or a thermoset film adhesive.

In one embodiment, the thermoplastic film adhesive coupling the bondable layers Lₓ is selected from the group consisting of ethyl vinyl acetate (EVA) film adhesive, co-polyaminde film adhesive, co-polyester film adhesive, polypropylene film adhesive, polyethylene film adhesive, polyurethane film adhesive, multi-layered film adhesive, and combinations thereof.

In one embodiment, the thermoplastic film adhesive coupling the bondable layers Lₓ is selected from the group consisting of the reactive (polymerizable) thermoplastic resin may be reactive macrocyclic oligomeric polyester, reactive macrocyclic oligomeric polybutyleneterephthalate, reactive macrocyclic oligomeric polyethyleneterephthalate, reactive macrocyclic oligomeric polycarbonate, and reactive lactam monomers.

In one embodiment, the thermoplastic film adhesive coupling the bondable layers Lₓ is selected from the group consisting of epoxy resins, unsaturated polyester resins, vinyl ester resins, thermoset polyurethane resins, phenol-formaldehyde resins (phenolic resins), polyimide resins, silicone resins, crosslinked thermoplastic resins, e.g., cross linked polyethylene resins, cross linked polypropylene resins, and cross linked polyvinyl chloride resins.

In one embodiment, the hollow composite assembly 205 comprises “non-bonding” layers to separate smooth finished surfaces of the hollow composite assembly 205.

In one embodiment, the “non-bonded” layers are thin sheets of material, wherein the material is selected from the group consisting of steel, aluminum, and plastic.

In one embodiment, the plastic is advantageously selected from the group consisting of polyethyleneterephthalate (PET), silicone, fluorinated ethylene propylene, polytetrafluoroethylene (PTFE), perfluoroalkoxy polymer resin, PFA, polyfluoroalkanes, polyethylene film, and polypropylene film.

In one embodiment, a shape of the first surface 213 of the mold 220 is selected from the group consisting of flat, concave, convex, and combinations thereof.

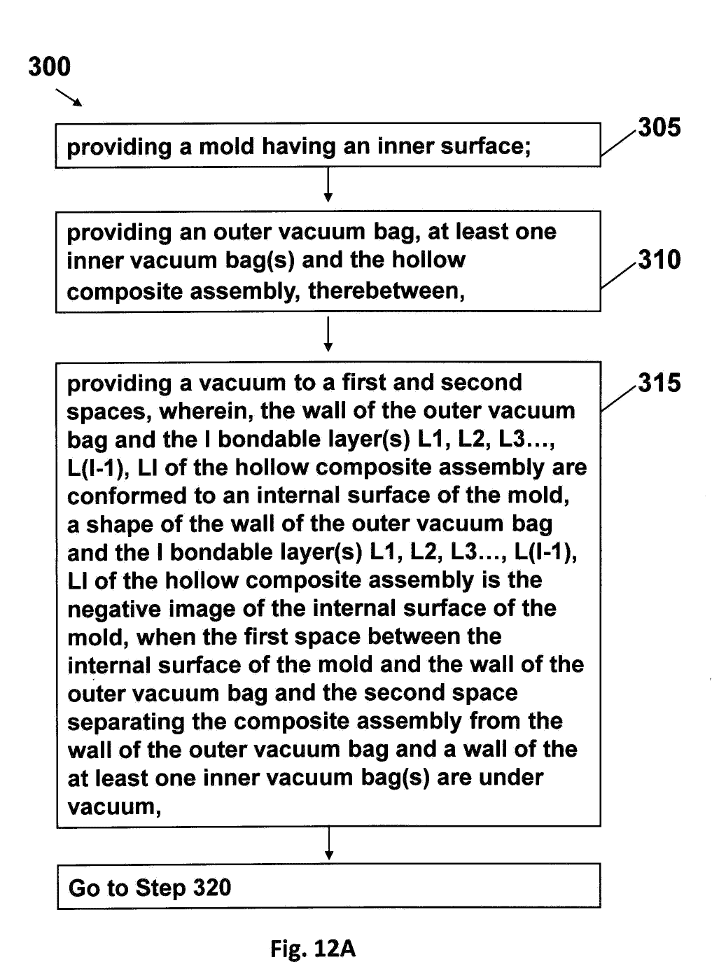

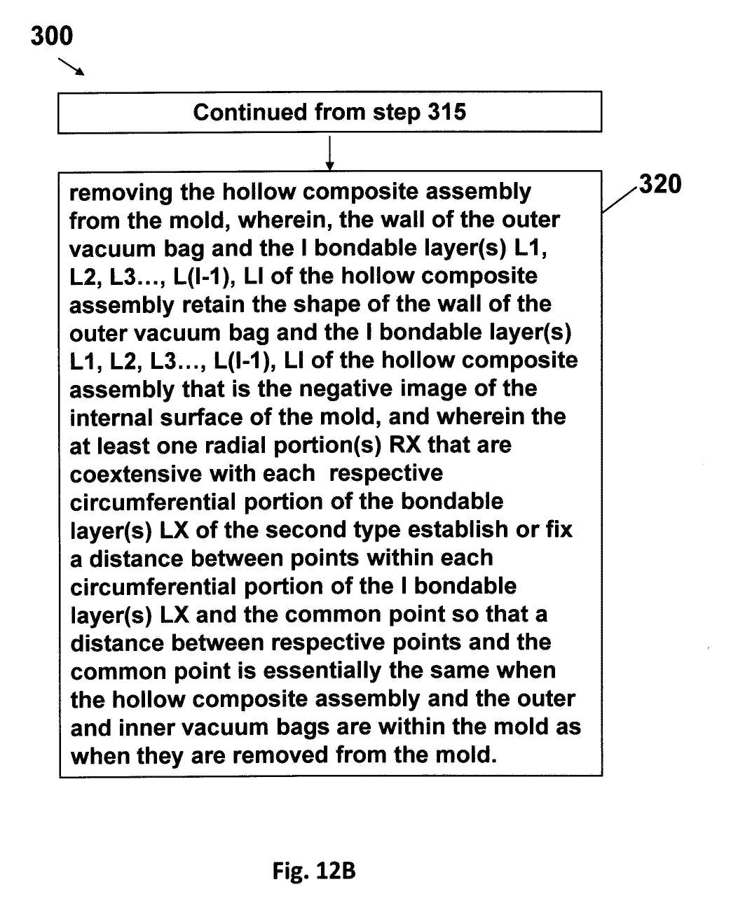

FIGS. 12A-12B depict a flow diagram describing a method 300 for making a hollow composite assembly 205. The method 300 comprises a step 305 in which a mold 220, having an inner surface 213, is provided.

In a step 310 of the method 300 a vacuum bag assembly 133 comprising: an outer vacuum bag 201, j at least one inner vacuum bag(s) 203, 204 and the hollow composite assembly 205, therebetween, is provided.

The hollow composite assembly 205 comprises i bondable layer(s) L_{X} between the inner at least one vacuum bag(s) 203, 204 and the outer vacuum bag 201. The i bondable layer(s) Lₓ comprise i₁ bondable layer(s) Lₓ of a first type and i₂ bondable layer(s) Lₓ of a second type, wherein Cₓ circumferential portion(s) 133 of the i bondable layer(s) Lₓ surround a common reference point 160 within the hollow composite assembly 205, wherein x=1, 2, 3, . . . (i−1), i. I may be any positive integer greater than or equal to 1.

The number i of bondable layer(s) may be represented by formula 1, as follows:

i=i₁+i₂, wherein i₁≧0, and i₂≧0, and wherein i₁+i₂≧1. (1)

The i bondable layer(s) L_{X} of the first and second types are denoted as L₁, L₂, L₃ . . . , L₍ᵢ₋₁₎, Lᵢ, in order of decreasing distance between a respective reference point 163, 166, 167, 169, and 171 within the C_{X} circumferential portion(s) 133 of the bondable layer(s) Lₓ of the first and second types and the common reference point 160. Each of the i₂ bondable layer(s) L_{X} of the second type comprises at least one Rₓ radial portion(s) 127 that are coextensive with each respective Cₓ circumferential portion(s) 133 of the i₂ bondable layer(s) Lₓ of the second type.

Cₓ Circumferential portion(s) 133 of the i₁ bondable layer(s) Lₓ of the first type, wherein x=1, 2, and 3, have inner surface(s) 236, 238, and 240, and outer surface(s) 246, 248, and 250. Cₓ circumferential portion(s) 133 of the i bondable layer(s) Lₓ of the second type, wherein x=(i−1) and i, have inner surface(s) 242 and 244, and outer surfaces 252 and 254.

Rₓ radial portion(s) 127 of the i₂ bondable layer(s) Lₓ of the second type, wherein x=(i−1) and I, have inner surface(s) 262, and 260, and 270, and outer surfaces 256, 258.

A distance between reference points 163, 166, 167, 169, and 171 along each outer surface of the Cₓ circumferential portion(s) 133 of the i bondable layer(s) L_{X} of the first and second type and the common reference point 160 is greater than a distance between a respective point along the inner surface(s) 236, 238, 240, 242, and 244 of the Cₓ circumferential portion(s) 133 of the i bondable layer(s) Lₓ and the common reference point 160.

In the step 315 of the method 300, a vacuum is provided to the first 107 and second 115 spaces. The vacuum assembly 137, which includes the wall 202 of the outer vacuum bag 201, the i bondable layer(s) L₁, L₂, L₃ . . . , L₍ᵢ₋₁₎, Lᵢ of the first and second types of the hollow composite assembly 205, and the wall(s) 208, 210 of the j at least one inner vacuum bag(s) 203, 204 is conformed to an internal surface 213 of the mold 220, so that a shape of the wall 202 of the outer vacuum bag 201, the i bondable layer(s) L₁, L₂, L₃ . . . , L₍ᵢ₋₁₎, Lᵢ of the first and second types of the hollow composite assembly 205, and the wall(s) 208, 210 of the inner vacuum bag(s) 203, 204 is the negative image of the internal surface 213 of the mold 220, when the first space 107 between the internal surface 213 of the mold 220 and the wall 202 of the outer vacuum bag 201 and the second space 115 separating the composite assembly 205 from the wall 202 of the outer vacuum bag are under vacuum.

In a step 320 of the method 300, the hollow composite assembly 205 is removed from the mold 220. The vacuum assembly 137 that includes the wall 202 of the outer vacuum bag 201, the i bondable layer(s) L₁, L₂, L₃ . . . , L_{(I-1)}, L_{I} of the hollow composite assembly 205, and the wall(s) 208, 210 of the j at least one inner vacuum bag(s) 203, 204 are conformed to an internal surface 213 of the mold 220, so that a shape of the wall 202 of the outer vacuum bag 201, the i bondable layer(s) L₁, L₂, L₃ . . . , L_{(I-1)}, L_{I} of the first and second types of the hollow composite assembly 205, and the wall(s) 208, 210 of the j at least one inner vacuum bag(s) 203, 204 is the negative image of the internal surface 213 of the mold 220, when the first space 107 between the internal surface 213 of the mold 220 and the wall 202 of the outer vacuum bag 201 and the second space 115 separating the composite assembly 205 from the wall 202 of the outer vacuum bag 201 are under vacuum.

The vacuum assembly 137 that includes the wall 202 of the outer vacuum bag 201, the i bondable layer(s) L₁, L₂, L₃ . . . , L_{(I-1)}, L_{I} of the hollow composite assembly 205, and the wall(s) 208, 210 of the j at least one inner vacuum bag(s) 203, 204 retains a shape of the wall 202 of the outer vacuum bag 201, the i bondable layer(s) L₁, L₂, L₃ . . . , L_{(I-1)}, L_{I} of the hollow composite assembly, and the wall(s) 208, 210 of the j at least one inner vacuum bag(s) 203, 204, that is the negative image of the internal surface 213 of the mold 220, and the at least one R_{X} radial portion(s) 127 that are coextensive with each respective Cₓ circumferential portion(s) 133 of the bondable layer(s) L_{X} of the second type establish or fix a distance “d” between reference points 163, 166, 167, 169, and 171 within each Cₓ circumferential portion(s) 133 of the i bondable layer(s) L_{X} of the first and second types and the common reference point 160, so that a distance between respective reference points 163, 166, 167, 169, and 171 and the common reference point 160 is essentially the vacuum assembly 137 is within the mold 220, as when the vacuum assembly 137 is removed from the mold 220.

In one embodiment of the step 310 of the method 300, at least two inner vacuum bag(s) 203, 204 are provided, i.e., j is greater than or equal to two.

In one embodiment of the step 315 of the method 300, the hollow composite assembly 205 and j at least one inner vacuum bag(s) 203, 204 are heated to a temperature greater than or equal to 25° C. inside the outer vacuum bag 201, after applying a vacuum to the first 107 and second spaces 115.

In one embodiment of the step 315 of the method 300, the hollow composite assembly 205 and at least one inner vacuum bag(s) 203, 204 are heated between about 50° C. and about 250° C. inside the outer vacuum bag 201 after applying a vacuum to the first 107 and second spaces 115.

In one embodiment of the step 315 of the method 300, the hollow composite assembly 205 and at least one inner vacuum bag(s) 203, 204 are heated between about 100° C. and about 250° C. inside the outer vacuum bag 201 after applying a vacuum to the first 107 and second spaces 115.

In one embodiment of the step 315 of the method 300, the hollow composite assembly 205 and at least one inner vacuum bag(s) 203, 204 are heated between ambient temperature and 250° C. inside the outer vacuum bag 201 after applying a vacuum to the first 107 and second spaces 115.

In one embodiment of the step 315 of the method 300, contact heating is used for heat processing the vacuum assembly 137, which includes the wall 202 of the outer vacuum bag 201, the i bondable layer(s) L₁, L₂, L₃ . . . , L_{(I-1)}, L_{I} of the first and second types of the hollow composite assembly 205, and the wall(s) 208, 210 of the j at least one inner vacuum bag(s) 203, 204. The wall 202 of the outer vacuum bag 201, the i bondable layer(s) L₁, L₂, L₃ . . . , L_{(I-1)}, L_{I} of the first and second types of the hollow composite assembly 205, and the wall(s) 208, 210 of the j at least one inner vacuum bag(s) 203, 204 are conformed to the internal surface 213 of the mold 220, forming the wall 202 of the outer vacuum bag 201, the i bondable layer(s) L₁, L₂, L₃ . . . , L_{(I-1)}, L_{I} of the first and second types of the hollow composite assembly 205, and the wall(s) 208, 210 of the j at least one inner vacuum bag(s) 203, 204 into a shape that is the negative image of the inner surface 213 of the mold 220.

Hereinafter, “contact heating” means direct, intimate contact heat processing of the vacuum assembly 137 by a heating source other than the mold 220. The heating source may be any heating tool capable of ballistically heating the vacuum assembly 137, so that the mold 220 does not have to be cycled between the upper and lower temperature ranges, e.g. between ambient temperature and 250° C. in order to heat process the contact surface 126 of the vacuum assembly 137.

In one embodiment of the step 315 of the method 300, heating the vacuum assembly 133 that includes the hollow composite assembly 205 and j at least one inner vacuum bag(s) 203, 204 in the outer vacuum bag 201 is faster than heating apparatus 200, that includes the mold 220, when using the same heat source, because this avoids having to heat the mold 220, which may have considerably more mass than the hollow composite assembly 205 and at least one inner vacuum bag(s) 203, 204 in the outer vacuum bag 201.

In one embodiment, the “Hot” contact surface 126 of the vacuum assembly 137 is the wall 202 of the outer vacuum bag 201 and the i bondable layer(s) L₁, L₂, L₃ . . . , L_{(I-1)}, L_{I} of the first and second types of the hollow composite assembly 205. The wall 202 of the outer vacuum bag 201 and the i bondable layer(s) L₁, L₂, L₃ . . . , L_{(I-1)}, L_{I} of the first and second types of the hollow composite assembly 205 are conformed to an internal surface 213 of the mold 220, so that a shape of the wall 202 of the outer vacuum bag 201, the i bondable layer(s) L₁, L₂, L₃ . . . , L_{(I-1)}, L_{I} of the first and second types of the hollow composite assembly 205, and the at least one wall(s) 208, 210 of the j inner vacuum bag(s) 203, 204 becomes the negative image of the internal surface 213 of the mold 220 when a vacuum is reapplied to conform the outer surface 126 of the vacuum assembly 137 to the exact shape of the inner surface 213 of the mold 220 heat processing.

In one embodiment, the vacuum assembly 137 is returned to the mold 220 for a second heat processing, during which vacuum is reapplied to the first space 107 and second space 115 to conform the outer surface 126 of the vacuum assembly 137 to the inner surface 213 of the mold 220.

Hereinafter “Hot” means heat processing the contact surface 126 of the wall 202 of the outer vacuum bag 201 so that it has a temperature between ambient and 250° C.

In one embodiment of the step 315 of the method 300, a pressure inside the outer vacuum bag 201 is reduced to less than atmospheric pressure, so that the j at least one inner vacuum bag(s) 203, 204 expands.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying embodiments.

I claim:

1. An apparatus for free-forming a shape of a composite assembly, comprising:
a mold having a first surface;
a vacuum bag thereon, wherein the vacuum bag comprises a plurality of vacuum bag sheet(s), and
a composite assembly therein,
wherein the composite assembly comprises a plurality of bondable layers,
wherein at least one of the plurality of sheet(s) of the vacuum bag is between the plurality of bondable layers and the first surface of the mold, and
wherein the plurality of bondable layers are able to retain a shape which is the negative image of the mold when the pressure of the inside of the vacuum bag is reduced, even if the bag and plurality of bondable layers of the composite assembly are removed from the mold.

2. The apparatus of claim 1, wherein the plurality of bondable layers of the composite assembly are reactive polymer pre-impregnated reinforcement materials (pre-pregs).

3. The apparatus of claim 1, wherein the plurality of bondable layers of the composite assembly are layers of preformed sheets of various materials and thicknesses according to the intended use.

4. The apparatus of claim 1, wherein the plurality of bondable layer(s) of the composite assembly are preformed sheets on each side of a foam core, or other suitable core material.

5. The apparatus of claim 1, wherein the plurality of bondable layer(s) of the composite assembly are combinations of reactive polymer pre-impregnated reinforcement materials (pre-pregs), layers of preformed sheets of various materials and thicknesses according to the intended use, or preformed sheets on each side of a foam core, or other suitable core material.

6. The apparatus of claim 1, wherein the plurality of bondable layer(s) (Lₙ) are coupled by a bonding material.

7. The apparatus of claim 6, wherein bonding material is a thermoplastic or a thermoset film adhesive.

8. The apparatus of claim 7, wherein the thermoplastic film adhesive is selected from the group consisting of ethyl vinyl acetate (EVA) film adhesive, co-polyaminde film adhesive, co-polyester film adhesive, polypropylene film adhesive, polyethylene film adhesive, polyurethane film adhesive, multi-layered film adhesive, and combinations thereof.

9. The apparatus of claim 7, wherein the thermoplastic film is selected from the group consisting of the reactive (polymerizable) thermoplastic resin may be reactive macrocyclic oligomeric polyester, reactive macrocyclic oligomeric polybutyleneterephthalate, reactive macrocyclic oligomeric polyethyleneterephthalate, reactive macrocyclic oligomeric polycarbonate, and reactive lactam monomers.

10. (canceled)

11. The apparatus of claim 7, wherein the thermoset film is selected from the group consisting of epoxy resins, unsaturated polyester resins, vinyl ester resins, thermoset polyurethane resins, phenol-formaldehyde resins (phenolic resins), polyimide resins, silicone resins, crosslinked thermoplastic resins, e.g., cross linked polyethylene resins, cross linked polypropylene resins, and cross linked polyvinyl chloride resins.

12. The apparatus of claim 1, wherein the composite assembly comprises “non-bonding” layers to separate smooth finished surfaces of the composite assembly.

13. The apparatus of claim 12, wherein the non-bonding layer comprises a plastic or metal with a mold release agent between the non-bonding layer and the composite.

14. The apparatus of claim 12, wherein the non-bonding layers are thin sheets of material, wherein the material is selected from the group consisting of metal, and plastic.

15. The apparatus of claim 14, wherein the metal is selected from the group consisting of steel, aluminum, copper, silver, and tin.

16. The apparatus of claim 14, wherein the plastic is selected from the group consisting of polyethyleneterephthalate (PET), silicone, fluorinated ethylene propylene, polytetrafluoroethylene (PTFE), perfluoroalkoxy polymer resin, PFA, polyfluoroalkanes, polyethylene film, and polypropylene film.

17. The apparatus of claim 1, wherein a shape of the first surface of the mold is selected from the group consisting of flat, concave, convex, and combinations thereof.

18. A method for forming a shape of a hollow composite assembly, comprising:
providing a mold having a first surface and
a vacuum bag thereon,
wherein the vacuum bag comprises a plurality of vacuum bag sheet(s);
providing a composite assembly, comprising:
a plurality of bondable layers,
wherein the plurality of bondable layers of the composite assembly are contained within the plurality of sheets of the vacuum bag,
wherein at least one of the plurality of sheet(s) of the vacuum bag are between the plurality of bondable layers of the composite assembly and the first surface of the mold; and
reducing the pressure inside the plurality of sheet(s) of the vacuum bag so that the plurality of bondable layers are able to retain a shape which is the negative image of the first surface of the mold when the pressure of the inside of the vacuum bag is reduced even when the plurality of bondable layers of the composite assembly are removed from the mold.

19. The method of claim 18, further comprising removing the composite assembly and the vacuum bag from the mold and heating the composite assembly inside the vacuum bag between about 80° C. and 260° C.

20. The method of claim 18, wherein heating the composite assembly in the bag is faster than heating the mold and composite assembly when using the same heat source.

21. The method of claim 20, wherein contact heating is used, so that the contact surface temperature of the heat source does not have to be cycled like the contact surface temperature of the composite assembly.

22. The method of claim 18, wherein a pressure inside the vacuum bag is reduced to less than atmospheric pressure, so that the inner vacuum bag expands.

23. An apparatus for forming a composite assembly having a composite material support structure (web), comprising:
a mold having first and second surfaces;
an outer vacuum bag, a plurality of inner vacuum bag(s) and a composite assembly having a composite material support structure (web) therebetween,
wherein the composite material support structure (web) runs along an axis orthogonal to a longitudinal axis of the composite assembly,
wherein the outer vacuum bag has a shape of a tube,
wherein the outer vacuum bag comprises a first sheet conformed against the first surface of the mold and a second sheet conformed against a second surface of the mold,
wherein the composite assembly comprises at least one bondable layer(s) Lₙ, wherein n=0, −1, −2 . . . −i, and
wherein a first surface of the at least one bondable layer(s) Lₙ₌₀ of the composite assembly faces and conforms to either a shape of the first surface of the mold and a shape of the first sheet of the outer vacuum bag or to a shape of the second surface of the mold and to a shape of the second sheet of the outer vacuum bag,
wherein each successive underlying at least one bondable layer(s) Lₙ, wherein n=−1, −2, . . . −i, conforms to the respective overlying layer L₁₊ₙ,
wherein n=−2, −3, . . . −i,
wherein Lₙ, wherein n=−1, −2, . . . −i+1, represents successive underlying at least one bondable layer(s) (Lₙ) of the composite assembly, wherein n=−i, represents a bottom underlying at least one bondable layer(s) (Lₙ) of the composite assembly,
wherein the first and second sheet(s) of the vacuum bag separate the at least one bondable layer(s) (Lₙ) of a composite assembly from the first and second surfaces of the mold,
wherein the plurality of inner vacuum bag(s) comprise first and second radially expandable sheet(s), disposed about the web's axis, orthogonal to the longitudinal axis of the composite assembly, conformable to a shape of the at least one L₍₋ᵢ₎ layer(s) of the composite assembly, and
wherein the at least one bondable layer(s) of the composite assembly being conformed to the shape of the respective shape first sheet of the outer vacuum bag and the first surface of the mold or the shape of the second sheet of the outer vacuum bag and the second surface of the mold are able to retain a shape which is the negative image of the respective first and second surfaces when the vacuum bag is evacuated even if the bag and plurality of bondable layers of the composite assembly are removed from the mold.

24. An apparatus for retaining a shape of a hollow composite assembly, comprising:
a mold having an internal surface;
an outer vacuum bag, at least one inner vacuum bag(s) and the hollow composite assembly, therebetween,
wherein the hollow composite assembly comprises I bondable layer(s) L_{X} between the inner at least one vacuum bag(s) and the outer vacuum bag,
wherein the I bondable layer(s) Lₓ comprise i₁ bondable layer(s) L_{X} of a first type and i₂ bondable layer(s) L_{X} of a second type, wherein circumferential portions C_{X} of the i bondable layer(s) L_{X} surround a common point within the hollow composite assembly,
wherein X=1, 2, 3, . . . (i−1), i;
wherein the I bondable layer(s) L_{X} of the first and second types are denoted as L₁, L₂, L₃ . . . , L_{(I-1)}, L₁, in order of decreasing distance between a respective point within the circumferential portions of the bondable layer(s) L_{X} of the first and second types and the common point,
wherein i is any positive integer greater than or equal to 1,
wherein i=i₁+i₂,
wherein i₁≧0, and i₂≧0,
wherein i₁+i₂≧1,
wherein each i₂ bondable layer(s) Lₓ of the second type comprises at least one radial portion(s) Rₓ that are coextensive with each respective circumferential portion Cₓ of the bondable layer(s) L_{X} of the second type,
wherein the circumferential portions C_{X} of the i₁ bondable layer(s) L_{X} of the first type and the circumferential C_{X} and radial R_{X} portions of the i₂ bondable layer(s) L_{X} of the second type have outer and inner surfaces,
wherein a distance between points along each outer surface of the circumferential portions Cₓ of the I bondable layer(s) L_{X} and the common point is greater than a distance between a respective point along the inner surface of the circumferential portions C_{X} of the i bondable layer(s) L_{X} of the first and second types and the common point,
wherein a first space separates a wall of the outer vacuum bag from the internal surface of the mold, and
wherein a second space separates the hollow composite assembly from the wall of the outer vacuum bag and a wall of the at least one inner vacuum bag(s),
wherein, when the wall of the outer vacuum bag and the i bondable layer(s) L₁, L₂, L₃ . . . , L_{(I-1)}, L_{I} of the hollow composite assembly are conformed to the internal surface of the mold, a shape of the wall of the outer vacuum bag and the I bondable layer(s) L₁, L₂, L₃ . . . , L_{(I-1)}, L_{I} of the first and second types of the hollow composite assembly is the negative image of the internal surface of the mold, when the first space between the internal surface of the mold and the wall of the outer vacuum bag and the second space separating the composite assembly from the wall of the outer vacuum bag and a wall of the at least one inner vacuum bag(s) are under vacuum,
wherein the at least one radial portion(s) Rₓ that are coextensive with each respective circumferential portion Cₓ of the bondable layer(s) L_{X} of the second type establish or fix a distance between points within each circumferential portion Cₓ of the I bondable layer(s) L_{X} of the first and second types and the common point so that a distance between respective points and the common point is essentially the same when the hollow composite assembly and the outer and inner vacuum bags are within the mold as when they are removed from the mold.

25. The apparatus for retaining the shape of the hollow composite assembly of claim 24, comprising j inner vacuum bag(s), and j is a positive integer greater than two.

26. An apparatus for retaining a shape of a hollow composite assembly, comprising:
an outer vacuum bag, at least one inner vacuum bag(s) and the hollow composite assembly, therebetween,
wherein the hollow composite assembly comprises I bondable layer(s) L_{X} between the inner at least one vacuum bag(s) and the outer vacuum bag,
wherein the i bondable layer(s) L_{X} comprise i₁ bondable layer(s) L_{X} of a first type and i₂ bondable layer(s) L_{X} of a second type, wherein circumferential portions C_{X} of the i bondable layer(s) L_{X} surround a common point within the hollow composite assembly,
wherein X=1, 2, 3, . . . (i−1), i;
wherein the I bondable layer(s) L_{X} of the first and second types are denoted as L₁, L₂, L₃ . . . , L_{(I-1)}, L_{I}, in order of decreasing distance between a respective point within the circumferential portions of the bondable layer(s) L_{X} of the first and second types and the common point,
wherein i is any positive integer greater than or equal to 1,
wherein i=i₁+i₂,
wherein i₁≧0, and i₂≧0
wherein i₁+i₂≧1,
wherein each bondable layer(s) L_{X} of the second type comprises at least one radial portion(s) R_{X} that are coextensive with each respective circumferential portion of the bondable layer(s) L_{X} of the second type,
wherein the circumferential portions of the i₁ bondable layer(s) L_{X} of the first type and the circumferential and radial portions of the i₂ bondable layer(s) L_{X} of the second type have outer and inner surfaces,
wherein a distance between points along each outer surface of the i bondable layer(s) L_{X} and the common point is greater than a distance between a respective point along the inner surface and the common point,
wherein a first space separates a wall of the outer vacuum bag from the internal surface of the mold, and
wherein a second space separates the composite assembly from the wall of the outer vacuum bag and a wall of the at least one inner vacuum bag(s),
wherein, when the wall of the outer vacuum bag and the i bondable layer(s) L₁, L₂, L₃ . . . , L₍ᵢ₋₁₎, Lᵢ of the hollow composite assembly are conformed to an internal surface of a mold, a shape of the wall of the outer vacuum bag and the I bondable layer(s) L₁, L₂, L₃ . . . , L₍ᵢ₋₁₎, Lᵢ of the hollow composite assembly is the negative image of the internal surface of the mold, when the first space between the internal surface of the mold and the wall of the outer vacuum bag and the second space separating the composite assembly from the wall of the outer vacuum bag and a wall of the at least one inner vacuum bag(s) are under vacuum,
wherein the at least one radial portion(s) R_{X} that are coextensive with each respective circumferential portion of the bondable layer(s) L_{X} of the second type establish or fix a distance between points within each circumferential portion of the I bondable layer(s) L_{X} and the common point so that a distance between respective points and the common point is essentially the same when the hollow composite assembly and the outer and inner vacuum bags are within the mold as when they are removed from the mold.

27. The apparatus for retaining the shape of the hollow composite assembly of claim 26, comprising j inner vacuum bag(s), and j is a positive integer greater than two.

28. The apparatus of claim 26, wherein the inner vacuum bag is expandable when the outer vacuum bag is evacuated.

29. The apparatus of claim 26, wherein the bondable layer(s) (L_{X}) of the hollow composite assembly are reactive polymer pre-impregnated reinforcement materials (pre-pregs).

30. The apparatus of claim 26, wherein the bondable layer(s) (L_{X}) of the hollow composite assembly are layers of preformed sheets of various materials and thicknesses according to the intended use.

31. The apparatus of claim 26, wherein the bondable layer(s) (L_{X}) of the hollow composite assembly are preformed sheets on each side of a foam core, or other suitable core material.

32. The apparatus of claim 26, wherein the bondable layer(s) (L_{X}) of the hollow composite assembly are combinations of reactive polymer pre-impregnated reinforcement materials (pre-pregs), layers of preformed sheets of various materials and thicknesses according to the intended use, or preformed sheets on each side of a foam core, or other suitable core material.

33. The apparatus of claim 26, wherein the bondable layer(s) (L_{X}) are coupled by a bonding material.

34. The apparatus of claim 26, wherein bonding material is a thermoplastic or a thermoset film adhesive.

35. The apparatus of claim 34, wherein the thermoplastic film adhesive is selected from the group consisting of ethyl vinyl acetate (EVA) film adhesive, co-polyaminde film adhesive, co-polyester film adhesive, polypropylene film adhesive, polyethylene film adhesive, polyurethane film adhesive, multi-layered film adhesive, and combinations thereof.

36. The apparatus of claim 34, wherein the thermoplastic film adhesive is selected from the group consisting of the reactive (polymerizable) thermoplastic resin may be reactive macrocyclic oligomeric polyester, reactive macrocyclic oligomeric polybutyleneterephthalate, reactive macrocyclic oligomeric polyethyleneterephthalate, reactive macrocyclic oligomeric polycarbonate, and reactive lactam monomers.

37. The apparatus of claim 34, wherein the thermoset film adhesive is selected from the group consisting of epoxy resins, unsaturated polyester resins, vinyl ester resins, thermoset polyurethane resins, phenol-formaldehyde resins (phenolic resins), polyimide resins, silicone resins, crosslinked thermoplastic resins, e.g., cross linked polyethylene resins, cross linked polypropylene resins, and cross linked polyvinyl chloride resins.

38. The apparatus of claim 26, wherein the hollow composite assembly comprises “non-bonding” layers to separate smooth finished surfaces of the hollow composite assembly.

39. The apparatus of claim 38, wherein the “non-bonding” layers are thin sheets of material, wherein the material is selected from the group consisting of metal and plastic.

40. The apparatus of claim 39, wherein the metal is selected from the group consisting of steel, aluminum, copper, silver, and tin.

41. The apparatus of claim 40, wherein the plastic is selected from the group consisting of polyethyleneterephthalate (PET), silicone, fluorinated ethylene propylene, polytetrafluoroethylene (PTFE), perfluoroalkoxy polymer resin, PFA, polyfluoroalkanes, polyethylene film, and polypropylene film.

42. The apparatus of claim 26, wherein a shape of the first surface of the mold is selected from the group consisting of a flat shape, a concave shape, and a convex shape.

43. A method of making a hollow composite assembly, comprising:
providing a mold having an inner surface;
providing an outer vacuum bag, at least one inner vacuum bag(s) and the hollow composite assembly, therebetween,
wherein the hollow composite assembly comprises i bondable layer(s) L_{X} between the inner at least one vacuum bag(s) and the outer vacuum bag,
wherein the I bondable layer(s) L_{X} comprise i₁ bondable layer(s) L_{X} of a first type and i₂ bondable layer(s) L_{X} of a second type, wherein circumferential portions C_{X} of the I bondable layer(s) L_{X} surround a common point within the hollow composite assembly,
wherein X=1, 2, 3, . . . (i−1), i;
wherein the I bondable layer(s) L_{X} of the first and second types are denoted as L₁, L₂, L₃ . . . , L₍ᵢ₋₁₎, Lᵢ, in order of decreasing distance between a respective point within the circumferential portions of the bondable layer(s) L_{X} of the first and second types and the common point,
wherein I is any positive integer greater than or equal to 1,
wherein i=i₁+i₂,
wherein i₁≧0, and i₂≧0,
wherein i₁+i₂≧1,
wherein each bondable layer(s) L_{X} of the second type comprises at least one radial portion(s) R_{X} that are coextensive with each respective circumferential portion of the bondable layer(s) L_{X} of the second type,
wherein the circumferential portions of the i₁ bondable layer(s) L_{X} of the first type and the circumferential and radial portions of the i₂ bondable layer(s) L_{X} of the second type have outer and inner surfaces,
wherein a distance between points along each outer surface of the I bondable layer(s) L_{X} and the common point is greater than a distance between a respective point along the inner surface and the common point,
wherein a first space separates a wall of the outer vacuum bag from the internal surface of the mold, and wherein a second space separates the composite assembly from the wall of the outer vacuum bag and a wall of the at least one inner vacuum bag(s),
providing a vacuum to a first and second spaces,
wherein, the wall of the outer vacuum bag and the i bondable layer(s) L₁,
L₂, L₃ . . . , L₍ᵢ₋₁₎, Lᵢ of the hollow composite assembly are conformed to an internal surface of the mold, a shape of the wall of the outer vacuum bag and the I bondable layer(s) L₁, L₂, L₃ . . . , L₍ᵢ₋₁₎, Lᵢ of the hollow composite assembly is the negative image of the internal surface of the mold, when the first space between the internal surface of the mold and the wall of the outer vacuum bag and the second space separating the composite assembly from the wall of the outer vacuum bag and a wall of the at least one inner vacuum bag(s) are under vacuum,
removing the hollow composite assembly from the mold,
wherein, the wall of the outer vacuum bag and the I bondable layer(s) L₁,
L₂, L₃ . . . , L₍ᵢ₋₁₎, Lᵢ of the hollow composite assembly retain the shape of the wall of the outer vacuum bag and the I bondable layer(s) L₁, L₂, L₃ . . . , L₍ᵢ₋₁₎, Lᵢ of the hollow composite assembly that is the negative image of the internal surface of the mold, and
wherein the at least one radial portion(s) R_{X} that are coextensive with each respective circumferential portion of the bondable layer(s) L_{X} of the second type establish or fix a distance between points within each circumferential portion of the i bondable layer(s) L_{X} and the common point so that a distance between respective points and the common point is essentially the same when the hollow composite assembly and the outer and inner vacuum bags are within the mold as when they are removed from the mold.

44. The method of claim 43, comprising: providing j inner vacuum bag(s), wherein j is a positive integer greater than two.

45. The method of claim 43, further comprising removing the hollow composite assembly and the vacuum bag from the mold and heating the hollow composite assembly inside the vacuum bag between about 80° C. and 260° C.

46. The method of claim 43, wherein heating the hollow composite assembly in the bag is faster than heating the mold and composite assembly when using the same heat source.

47. The method of claim 43, wherein contact heating is used, so that the contact surface temperature of the heat source does not have to be cycled like the contact surface temperature of the hollow composite assembly.

48. The method of claim 43, wherein a pressure inside the vacuum bag is reduced to less than atmospheric pressure, so that the inner vacuum bag expands.

49. A method for fixing the solid geometric shape of a hollow composite assembly, comprising:
withdrawing air from a first space, in antiparallel directions, resulting in conforming a wall of an inner vacuum bag to a surface of a mold;
withdrawing air from a second space, in antiparallel directions, resulting in conforming a wall of an outer vacuum bag to a wall of the hollow composite assembly;
said conforming the wall of the outer vacuum bag to the wall of the hollow composite fixing the geometric shape of the hollow composite assembly, resulting in the hollow composite assembly having a shape in the negative image of the surface of the mold.

50. The method of claim 50, wherein the pressure in first space may be allowed to return to atmospheric pressure, resulting in releasing the mold so it can be removed, thereby forming a cavity within the hollow composite assembly.

51. The method of claim 49, wherein the air is withdrawn from the first and second spaces by withdrawing air via pumping.

52. The method of claim 51, wherein the air is withdrawn by a mechanical pump, e.g., using a mechanical vacuum pump.
